(19) United States
(12) Patent Application Publication
(10) Pub. No.: US 2012/0113760 A1
(43) Pub. Date: May 10, 2012

(54) Time Indicating Device With Wearable Toys

(76) Inventor: Jai Pagrani, Hong Kong (HK)

(21) Appl. No.: 12/939,540

(22) Filed: Nov. 4, 2010

(51) Int. Cl. G04B 47/04

(52) U.S. Cl. 368/10

(57) ABSTRACT

A time indicating device with wearable toys is provided. The device includes a watch having a time indicating face and an opposing back, first and second straps, each having a proximal end for attachment with the watch and a distal end. The device also includes a first Velcro strip attached to a front side of the first strap, proximate the distal end and a complimentary Velcro strip attached to a back side of the second strap, proximate the distal end. The device further includes a first toy attached at a back side to a front side of the first strap, with a top of the first toy proximate the proximal end and a second toy attached at a back side to a front side of the second strap, with a top of the second toy proximate the proximal end. Each toy has a length less than a length of the respective strap.

### BACKGROUND OF THE INVENTION

This application relates to a watch with toys attached.

Wrist watches may come in many forms and designs. Beyond the functional aspects for time indication, various styles have been developed to meet the needs of customers. For example, rugged styles are often favored for everyday use by sportsmen, while elaborate watches made from precious metals may be desired for special occasions, or by those wishing to project a rich or sophisticated image. On the other hand, brightly colored and decorative watches may be chosen in an effort to express individuality or lightheartedness. It is desirable to have a playful watch style for adults and children, and especially for young children.

### BRIEF SUMMARY

In an embodiment, a time indicating device with wearable toys is provided. The device includes a watch having a time indicating face and an opposing back. The device also includes first and second straps, each having a proximal end for attachment with the watch and a distal end. The device further includes a first Velcro strip attached to a front side of the first strap, proximate the distal end and a complimentary Velcro strip attached to a back side of the second strap, proximate the distal end, for fastening with the first Velcro strip to hold the first and second straps together. The device also includes a first toy attached at a back side to a front side of the first strap, with a top of the first toy proximate the proximal end, and a second toy attached at a back side to a front side of the second strap, with a top of the second toy proximate the proximal end. The first and second toys have lengths that are less than lengths of the first and second straps, respectively.

In an embodiment, a time indicating device with removably attachable toys is provided. The device includes a watch having a time indicating face and an opposing back. The device also includes first and second straps, each having first ends attached with the watch and second ends distal to the watch. The device further includes a first toy having a front and an opposing back, the first toy removably attaching by its back to a front side of a first portion of the first strap, and a second toy having a front and an opposing back, the second toy removably attaching by its back to a front side of a first portion of the second strap. The device still includes a first Velcro strip attached to the front side of a second portion of the first strap, and a complimentary Velcro strip attached to a back side of a second portion of the second strap, for coupling with the first Velcro strip to join the second ends of the first and second straps together. The first portion of each strap is proximate the first end of the respective strap. The second portion of each strap is proximate the second end of the respective strap. The back of the toys corresponds to the back side of the watch and the back sides of the straps. Each toy has a length less than a length of the respective strap.

In an embodiment, a time indicating device with toys is provided. The device includes a watch having a time indicating face and an opposing back. The device also includes first and second straps, each having a first end for attaching with the watch, and a free end distal to the watch. Each strap includes a first strap portion with the first end and a distal end, a toy attached with the first strap portion at the distal end of the first strap portion, a second strap portion having the free end and an proximal end that is proximal to the distal end of the first strap portion' wherein the toy is attached to the second strap at the proximal end. The bottom of each toy is flatter than the top of the toy, and each toy has a length that is less than the length of the respective strap.

Additional embodiments and features are set forth in part in the description that follows. These additional embodiments and features will become apparent to those skilled in the art upon examination of the specification and claims, or may be learned by practice of the disclosed invention. A further understanding of the nature and advantages of the present invention may be realized by reference to the specification and the drawings.

### BRIEF DESCRIPTION OF THE DRAWINGS

FIG. 1A is a top view of a watch with wearable toys attached via optically transparent stitches on watch straps, according to an embodiment.

FIG. 1B is a bottom view of the watch of FIG. 1A.

FIG. 1C is a side view of the watch of FIGS. 1A and 1B.

FIG. 2A is a top view of a watch with wearable toys forming a portion of the straps, according to an embodiment.

FIG. 2B is a bottom view of the watch of FIG. 2A.

FIG. 2A is a side view of the watch of FIGS. 2A and 2B.

FIG. 3A is a top view of a watch with wearable toys, according to an embodiment.

FIG. 3B is a bottom view of the watch of FIG. 3A, showing metal eyelets used for fastening the toys with the watch straps, according to an embodiment.

FIG. 3C is a side view of the watch of FIGS. 3A and 3B, showing the wearable toys detached from the straps, according to an embodiment.

FIG. 4A is a top view of a watch with wearable toys, according to an embodiment.

FIG. 4B is a bottom view of the watch of FIG. 4A, showing buttons for attaching the toys with the watch straps.

FIG. 4C is a side view the watch of FIGS. 4A and 4B, illustrating detached wearable toys and showing fastening features on the toys, according to an embodiment.

FIG. 5A is a top view of a watch with wearable toys attached, illustrating additional dimensions, according to an embodiment.

FIG. 5B is a bottom view of the watch of FIG. 5A, showing elastic bands and attached fasteners for joining the toys with the watch straps, according to an embodiment.

FIG. 5C is a side view of the watch of FIGS. 5A and 5B, showing one toy partially detached from the watch straps.

FIG. 6A is a top view of a watch with wearable toys attached, illustrating additional dimensions, according to an embodiment.

FIG. 6B is a bottom view of the watch of FIG. 6A, showing elastic bands for sliding the toys onto the watch straps, according to an embodiment.

FIG. 6C is a side view of the watch of FIGS. 6A and 6B, illustrating removal of one toy from the watch straps, according to an embodiment.

FIG. 7A is a top view illustrating exemplary dimensions of a wearable toy for attachment with a watch, according to an embodiment.

FIG. 7B is a side view of the toy of FIG. 7A, illustrating additional dimensions, according to an embodiment.

FIG. 7C is a bottom view of the toy of FIGS. 7A and 7B, showing still further dimensions, according to an embodiment.

FIG. 8A is a top view of a wearable toy, showing exemplary dimensions in accordance with an embodiment.

FIG. 8B is a side view showing further dimensions of the toy of FIG. 8A, in an embodiment.

FIG. 8C is a bottom view of the toy of FIGS. 8A and 8B, showing still further dimensions, in an embodiment.

FIG. 9A is a top view of a wearable toy showing dimensions according to an embodiment.

FIG. 9B is a side view of the toy of FIG. 9A, showing additional dimensions, according to an embodiment.

FIG. 9C is a bottom view of the toy of FIGS. 9A and 9B, showing further dimensions, according to an embodiment.

FIG. 10 is a bottom view of a watch with wearable toys attached with metal eyelets and a removable double lever spring bar, according to an embodiment.

### DETAILED DESCRIPTION

The present disclosure may be understood by reference to the following detailed description considered in conjunction with the drawings. Note that, for purposes of illustrative clarity, certain elements in the drawings are not drawn to scale. Reference numbers for items that appear multiple times may be omitted for clarity. Where possible, the same reference numbers are used throughout the drawings and the following description to refer to the same or similar parts.

This disclosure provides a time indicating device or a wrist watch with toys attached with opposing sides of the watch band, or strap. The toys may be stuffed toys, such as stuffed animals or stuffed objects of any types. The wrist watches have watch straps for fastening around a wearer's wrist. The straps may be made of plastic, leather, rubber, canvas, or other watch strap materials. For example, nylon or inexpensive plastic straps may be used for infants and kids under seven years old. More expensive and durable leather straps may be used in watches sized for older children and adults. In one aspect, each strap removably attaches to the body of the watch by a removable double lever spring bar, which allows the straps and toys to be removed from the watch for cleaning, without use of any tool (e.g., in a washer and a dryer, where the toys and straps are launderable). The straps may also attach to the watch by single lever spring bars, which allows the straps to be removed without use of a tool. For example, single lever spring bars may be used for watches for older children and adult. The straps may also attach to the watch by normal spring bars, which allows the straps to be removed by using a tool. The stuffed toys may be included as non-removable portions of the straps, or the toys and/or straps may include fasteners for attaching and removing the toys with/from the straps, for example when the toys are machine-washable but the straps are not.

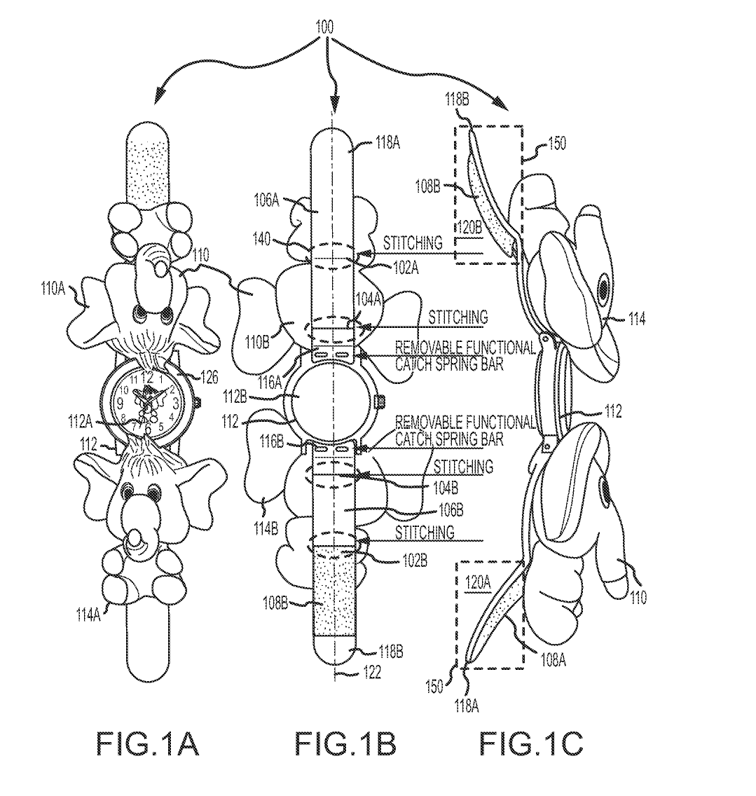

FIGS. 1A, 1B and 1C are top, bottom and side views, respectively, of a time indicating device 100 with two stuffed animals. FIGS. 1A-1C are best viewed together with the following description.

Device 100 includes a watch body 112, two straps 106A and 106B for fastening watch body 112 about a wearer's wrist, and two stuffed toys 110 and 114 attached to the straps 106A and 106B, respectively.

Watch body 112 (also referred to as “watch 112”) includes a time indicating face 112A and opposing back 112B. As shown, watch 112 has a circular shape and is left-to-right symmetrical about a centerline 122. However, watch 112 may take any shape, including but not limited to elliptical, ovoid, square and rectangular. Watch 112 may be of any style, color or color combination, and may include any conventional time display (i.e., hands or a digital display).

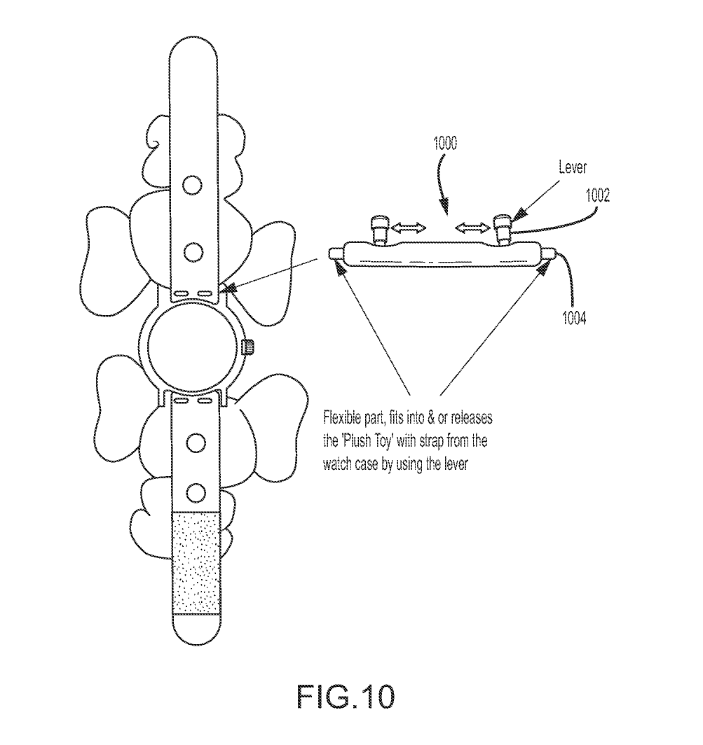

Straps 106A and 106B are coupled to watch 112 by removable double lever spring bars 116A and 116B, respectively. More details of removable double lever spring bars are provided in FIG. 10 and the related description. Straps 106A and 106B may be of substantially rectangular shape, rounding or narrowing towards strap ends 118A and 118B. Each of straps 106A and 106B has a front side, alligning with watch face 112A, and a back side, corresponding to watch back 112B, when straps 106A and 106B attach with watch 112.

Toy 110 has a front face 110A and an opposite back 110B. As shown in FIG. 1B, back 110B of stuffed toy 110 is attached to the front side of strap 106A through optically transparent stitches in at least two separate stitching areas 102A and 104A, shown bounded by dotted lines 140. Back 114B of toy 114 is attached to the front side of strap 106B through optically transparent stitches in at least two separate stitching areas 102B and 104B (also bounded by dotted lines 140).

One way of tightening the two straps around a wearer's wrist is to attach hook and loop closures, such as Velcro, to opposite sides of straps. As illustrated in FIGS. 1B and 1C, a Velcro strip 108B is attached to the back side of strap 106B near end 118B in area 120B bounded by dotted lines 150, and a complimentary Velcro strip 108A is attached to the front side of strap 106A near end 118A in area 120A bounded by dotted lines 150. It will be appreciated that complimentary Velcro closures may alternatively be placed with the front side of strap 106B and the back side of strap 106A. Velcro strip advantageously permits attachment of watch 112 about a human wrist while leaving space sufficient for toys 110, 114 that is, using a common clasp to attach the straps to a wrist would require toys 110, 114 to be of smaller dimension.

Straps 106A and 106B may attach via respective double lever spring bars 116A and 116B to an outer edge 126 of watch 112. Straps 106A and 106B may be removed from the watch by removing the double lever spring bars 116A and 116B, which may be accomplished without using any tool. Straps 106A and 106B may then be cleaned manually or laundered in a washing machine and dried in a dryer. In one aspect, straps 106A and 106B are plastic, and toys 110 and 114 are plush, stuffed toys.

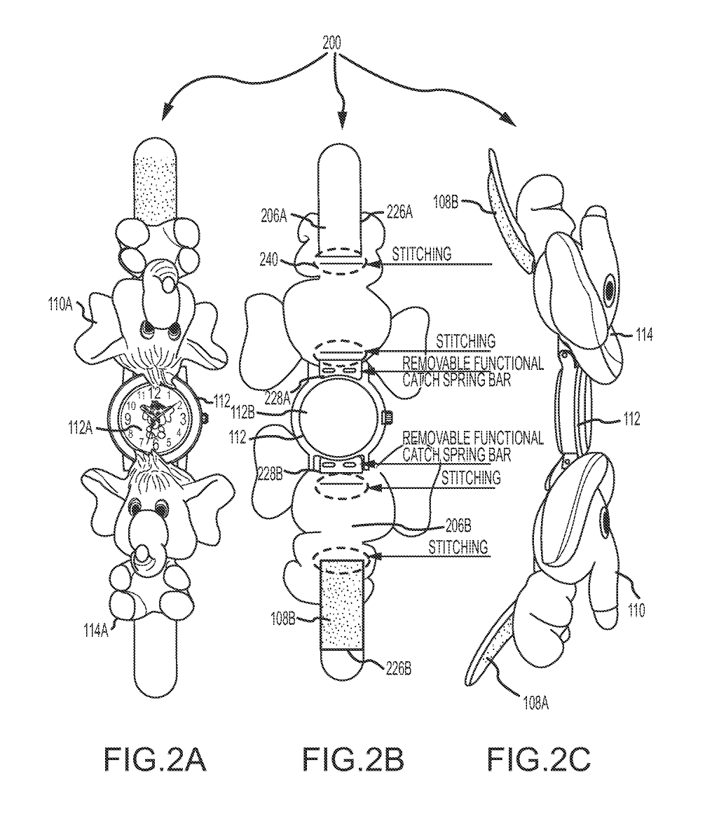

In an embodiment, watch 112 may attach with straps of a different strap style, as illustrated in FIGS. 2A, 2B, and 2C. A time indicating device 200 includes watch 112 with straps 206A and 206B. Stuffed toy 110 attaches with a first strap portion 228A, proximal to watch 112, and with a second strap portion 226A, distal to watch 112, such that the first strap portion 228A, toy 110 and the second strap portion 226A form strap 206A. Similarly, stuffed toy 114 may attach with a first strap portion 228B, proximal to watch 112, and with a second strap portion 226B, distal to watch 112, to form strap 206B on the other side of watch 112. Stuffed toy 110 may be attached at its back surface 110B with strap 206A (or with first and second strap portions 228A and 226A) through optically transparent stitches at least two separated stitching areas 202A and 204A, shown bounded by dotted lines 240. The back of stuffed toy 110 alligns with the back of the watch 112, when assembled with strap 206A. Similarly, stuffed toy 114 is attached with strap 206B (or strap portions 228B and 226B) through optically transparent stitches at least two separated stitching areas 202B and 204B.

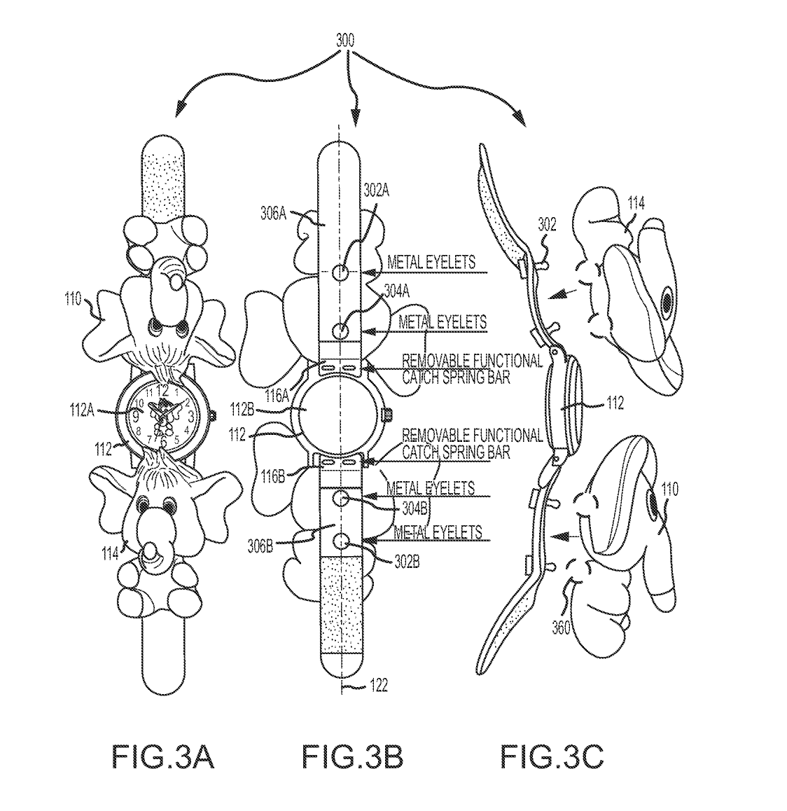

In an embodiment, watch 112 attaches with its straps using alternative fasteners (as an alternative to the stitches described above and illutstrated in FIG. 1B). As shown in FIGS. 3A-3C, a time indicating device 300 includes watch 112 and opposing straps 306A and 306B. Straps 306A and 306B include respective pairs of metal eyelets eyelets 302A and 304A, and 302B and 304B. Eyelets 302 and 304 are for example positioned along centerline 122 through watch 112 and straps 306A and 306B. FIG. 3C is a side view of device 300, illustrating toys 110 and 114 detached from metal eyelets 302A and 304A, and 302B and 304B, respectively. Eyelets 302 and 304 have mating parts bounded by dotted lines 360 for attaching with toys 110 and 114. One or both of toys 110 and 114 may be removed from eyelets 302 and 304 for cleaning or play. As described with respect to FIGS. 1A-1C, double lever spring bars 116A and 116B may be used to attach straps 306A and 306B with watch 112, facilitating removal of the straps from the watch without using any tool.

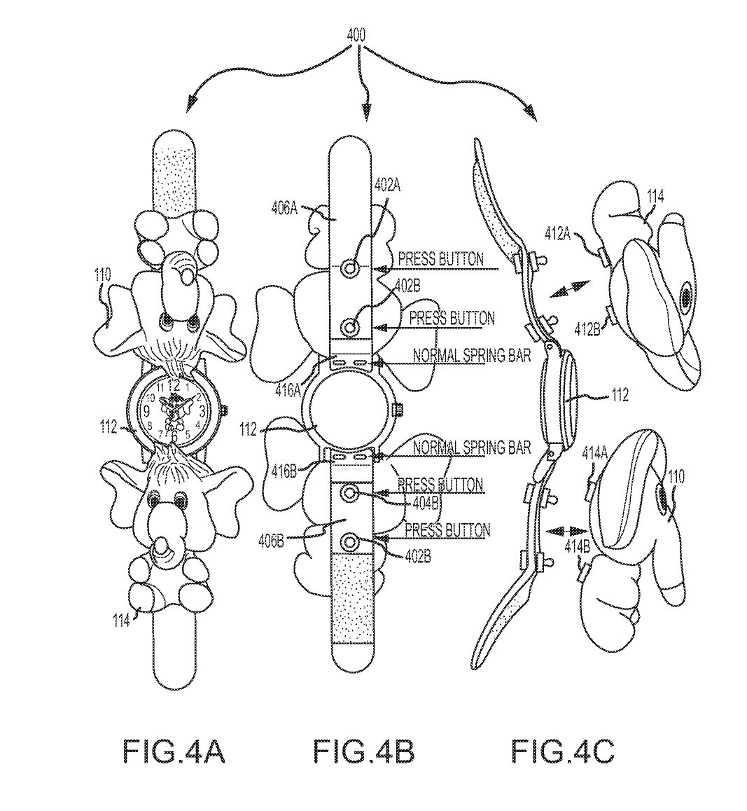

In an embodiment, watch 112 includes press buttons as fasteners for removably coupling the toys to the straps. FIGS. 4A-C are front, back, and side views of time indicating device 400 including press buttons 402 and 404 to attach the stuffed toys 110 and 114 with watch straps 406A and 406B. Mating parts 412A-B and 414A-B attach with back surfaces of stuffed toys 110 and 114, and are configured for mating with press buttons 402 and 404. Similar to metal eyelets, buttons 402 and 404 and corresponding mating parts 412 and 414 allow the toys to be attached with and removed from straps 406A and 406B. Watch 112 may attach with straps 406A and 406B via normal spring bars 416A and 416B, respectively. Normal spring bars 416A and 416B have no lever and generally have lower cost than the removable double lever spring bars. However, it will be appreciated that double lever spring bars, such as bars 116A and 116B, may be used in place of normal spring bars 416A and 416B or single lever spring bars.

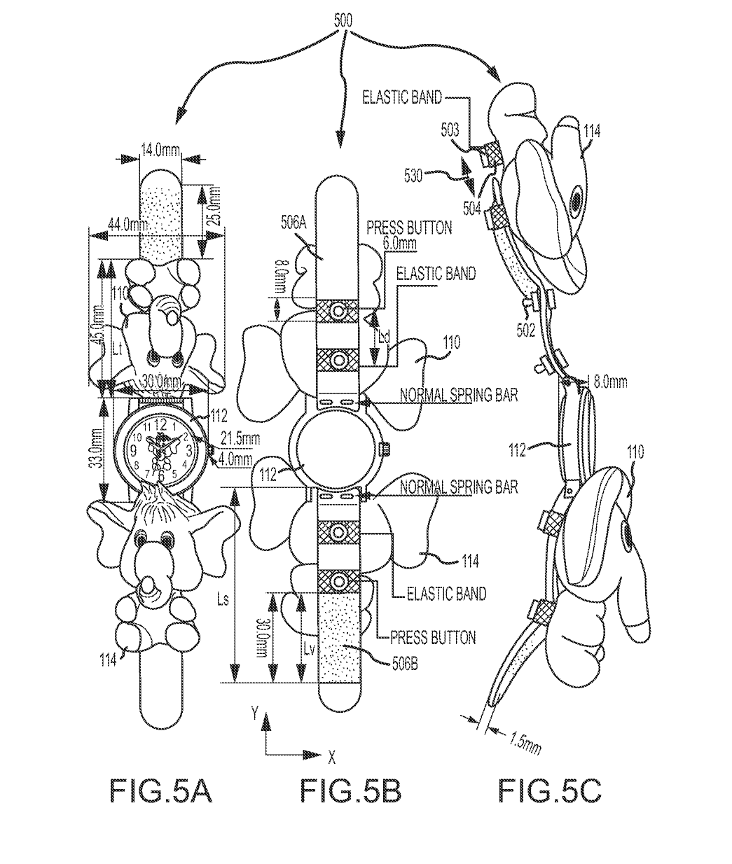

FIGS. 5A-C are front, back, and side views of an alternative embodiment for attaching toys to straps of a watch by using elastic bands with press buttons. FIGS. 5A-C are front, back, and side views of time indicating device 500 including elastic bands 504 attached with press buttons 503 for attaching the stuffed toys 110 and 114 to watch straps 506A and 506B. Exemplary dimensions for any of the straps, watches, press buttons and Velcro closures described herein are also shown in FIGS. 5A-C. Watch 112 may attach with straps 506A and 506B via normal spring bars or removable double lever spring bars.

In an embodiment, strap length Lₛ is greater than a sum of Velcro strip length Lᵥ and a distance L_{d} between two separated attachments (e.g. buttons 402, 404, stitching areas 140, 240, metal eyelets 302, 304, and elastic bands 604) for each toy to the respective strap. Mathematically, Lₛ>Lᵥ+L_{d}.

A ratio Rv of the Velcro strip length Lv to the strap length Ls is expressed in the following equation:

Rᵥ=Lᵥ/Lₛ

where Rᵥ may vary from 0.2 to 0.6 such that a Velcro strip is long enough to hold onto a complimentary Velcro strip when the straps are wrapped around a person's wrist.

The toy length Lₜ is at least 40% of the strap length Lₛ such that the toy may not be too small to be playful. Also, each of toys 110 and 114 cannot be too long (dimension y) to attach to the watch straps (e.g. 106A, 106B); that is, Velcro strips 108A and 108B should exist at the end of each of straps 106A and 106B in sufficient size (e.g., Rv is 0.4) such that the straps 106A and 106B can close around a human wrist (not shown) and clasp together. The width X of toys 110 and 114 has no similar limitation but appropriately scales to the length y of toys 110 and 114. A ratio Rₜ of the toy length to the strap length is expressed in the following equation:

Rₜ=Lₜ/L_{S},

where Rₜ ranges from 0.4 to 0.8. The strap length Lₛ is the same for both sides. For example, both straps 506A and 506B have a strap length of 75 mm. Preferably, the toy length Lₜ may range from 45 mm to 55 mm. Preferably, the ratio Rₜ is 0.6 to 0.65.

Time indicating device 500 includes dual straps 506A and 506B, which include press buttons 502. Toy 114 has two elastic bands 504 attached to its back. Each strap 504 supports one mating portion 503 for mating with a press button 502. Directional arrow 530 indicates directions for sliding toy 114 onto or off of strap 506B (via elastic band 504). Once in place on strap 506B (i.e., once mating portions 503 are aligned with press buttons 502), pressure is applied to the front of toy 114 over portions 503 and buttons 502, to snap toy 114 into place on strap 506B. Toy 110 is attached to strap 506A through sliding and pressing, as illustrated for toy 114 on strap 506B. Buttons 502 fix toys 110 and 114 to respective straps 506A and 506B such that the toys do not slide on the straps, once affixed.

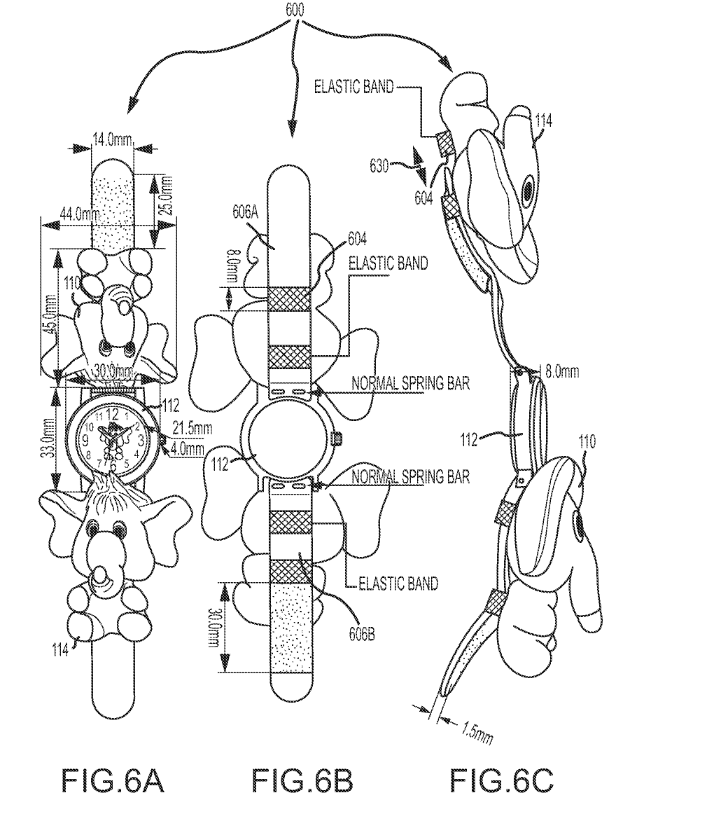

FIGS. 6A-C are front, back, and side views of a time indicating device 600 including watch 112 and straps 606A and 606B that fasten with toys 110 and 114 using alternative fastening structure. Exemplary dimensions of straps 606 and watch 112 are also illustrated in FIGS. 6A-C.

Two elastic bands 604 attached to the back of each stuffed toy 110, 114. Elastic bands 604 (and thus attached toys 110/114) may be slid onto and off of straps 606A-B as indicated by directional arrow 630. In this case, toys 110 and 114 are not fixed in a particular position along straps 606A and 606B, but may slide along the straps.

Toys 110 and 114 may be made of machine washable and dryable materials, for easy laundering when detached from watch 112 as shown in FIGS. 3A-C, 4A-C, 5A-C, and 6A-C. When straps are washable (e.g., straps are made of plastic, nylon, canvas or other washable fabric or material), the straps may be removed and washed together with the toys. For example, straps 106 and 206 (see FIGS. 1A-C and 2A-C) are preferably made with a washable material, so that they may be removed from watch 112 (via double lever spring catch bars 116 without use of any tool) and laundered with stitched-on toys 110 and 114.

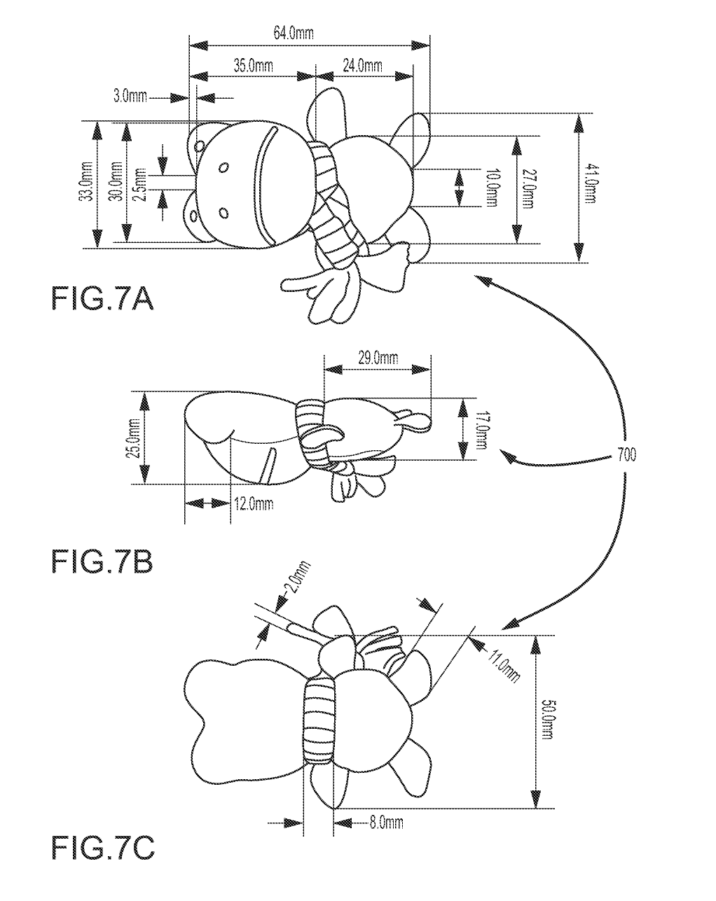

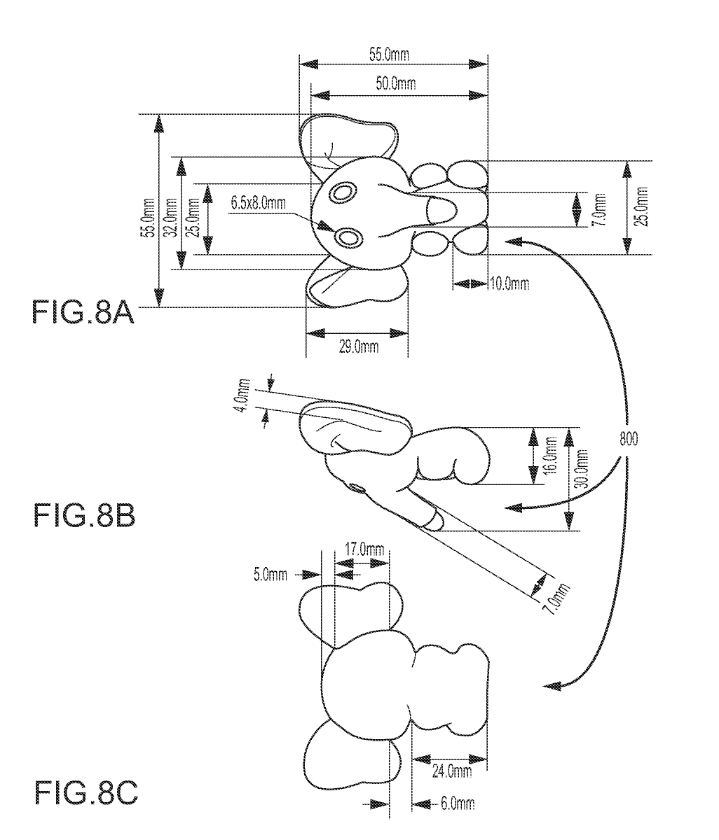

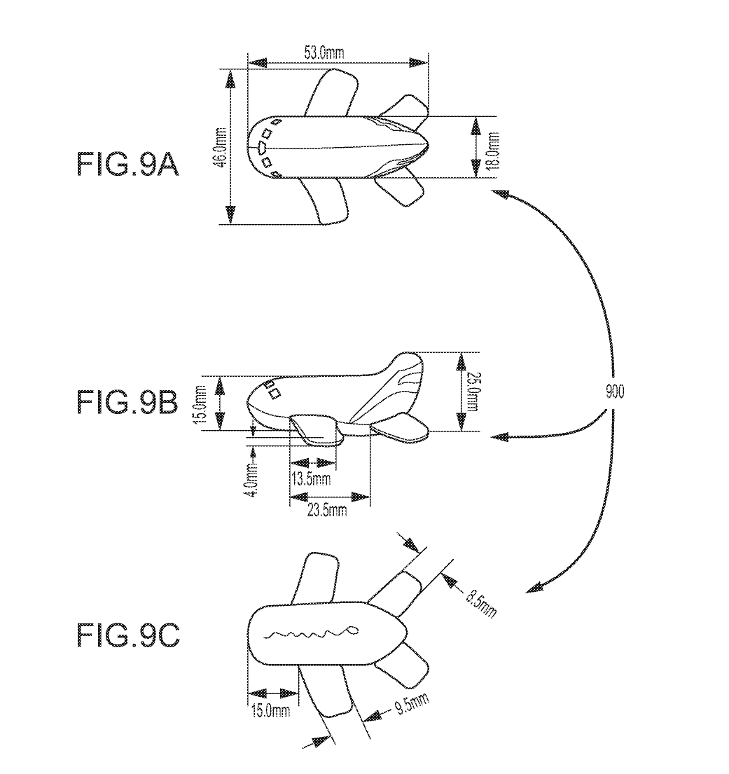

It will be appreciated that toys 110 and 114 need not take on the appearance of elephants, as in FIGS. 1A-6C, but may take on any animal or object form, such as a cow, a frog, a dog, a truck, a cloud, a car or an airplane. For example, FIGS. 7A-C show a stuffed frog 700 and its exemplary dimensions. FIGS. 8A-8C show exemplary dimensions of an elephant toy 800. FIGS. 9A-C show a stuffed airplane toy 900 with exemplary dimensions. Any of toys 700, 800 and 900 may serve in place of one or both of toy 110 or 114, in any of the above-described embodiments. Generally, stuffed toys are sized in accordance with a desired appearance with respect to watch 112 or watch straps. More specifically, the length of the stuffed toy must be smaller than the strap length, or the watch may be difficult to fasten on a wearer's wrist. In a particular embodiment, stuffed toys 110 and 114 have dimensions shown with respect to elephant toy 800 of FIGS. 8A-C. It will be appreciated by those of skill in the art that the stuffed toys may take the appearance of any animal or any object of any color, color combination, shape, and dimensions, so long as the dimensions of the toys are compatible with that of the watch (e.g., as long as the toys are shorter than the straps).

FIG. 10 shows a removable double lever spring bar 1000. Double lever spring bar 1000 includes two levers 1002 functionally coupled with two pins 1004 within double lever spring bar 1000. Pins 1004 are flat and flexible and are inserted into locks in a watch strap (not shown). Double lever spring bar 1000 allows consumers to remove the strap from the watch body without use of any tool. As illustrated in FIG. 10, in order to remove the strap from the watch body, levers 1002 may be pushed towards each other to retract pins 1004 into the ends of the double lever spring bar 1000. Retracting pins 1004 releases them from locks (e.g., channels) in a watch strap, allowing removal of the strap. In contrast, a normal spring bar 416 may be used for a children's watch. Such a normal spring bar requires a tool to remove the strap from the watch, thus preventing a child from removing the straps and potentially damaging or losing parts or all of the time indicating device.

The watches with wearable toys may be retained in watch cases. The watch cases may be made of a plastic material, such as polycarbonate, acrylic, polyvinyl chloride (PVC), and polyurethane. Such plastic watch cases may be used for younger children. For older children and adults, the watch cases may be made of a metal material which is generally more expensive than the plastic material, for example, stainless steel, brass, aluminum, or other metal alloys.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed:

1. A time indicating device with wearable toys, comprising:
a watch having a time indicating face and an opposing back;
first and second straps, each having a proximal end for attachment with the watch and a distal end;
a first Velcro strip attached to a front side of the first strap, proximate the distal end;
a complimentary Velcro strip attached to a back side of the second strap, proximate the distal end, for fastening with the first Velcro strip to hold the first and second straps together;
a first toy attached at a back side to a front side of the first strap, with a top of the first toy proximate the proximal end; and
a second toy attached at a back side to a front side of the second strap, with a top of the second toy proximate the proximal end.

2. The time indicating device of claim 1, wherein the attachment means comprises optically transparent stitches for fixing each toy to its respective strap, in at least two separate areas between the first and second ends of the respective strap.

3. The time indicating device of claim 1, further comprising a pair of metal spring bars coupled to the first ends of the straps and to the watch, for attaching the straps to the watch.

4. The time indicating device of claim 1, wherein the toy comprises a stuffed toy.

5. The time indicating device of claim 1, wherein the first and second straps comprises a material selected from the group consisting of leather, plastic, rubber, and fabric.

6. The time indicating device of claim 1, wherein each toy attaches to the respective strap in two separated attaching areas, each strap has a length greater than a sum of a Velcro strip length and a distance between the two separated attaching areas

7. The time indicating device of claim 1, wherein ratios of the lengths of the first and second toys to respective lengths of the first and second straps range from 0.4 to 0.8

8. The time indicating device of claim 1, wherein ratios of the lengths of the first Velcro strip and the complimentary Velcro strip to respective lengths of the first and second straps range from 0.2 to 0.6.

9. A time indicating device with removably attachable toys, comprising:
a watch having a time indicating face and an opposing back;
first and second straps, each having first ends attached with the watch and second ends distal to the watch;
a first toy having a front and an opposing back, the first toy removably attaching by its back to a front side of a first portion of the first strap;
a second toy having a front and an opposing back, the second toy removably attaching by its back to a front side of a first portion of the second strap;
a first Velcro strip attached to the front side of a second portion of the first strap; and
a complimentary Velcro strip attached to a back side of a second portion of the second strap, for coupling with the first Velcro strip to join the second ends of the first and second straps together;
wherein the first portion of each strap is proximate the first end of the respective strap, the second portion of each strap is proximate the second end of the respective strap, and the back of the toys corresponds to the back side of the watch and the back sides of the straps.

10. The time indicating device of claim 9, wherein the toy comprises stuffed toy.

11. The time indicating device of claim 9, wherein the first and second straps comprise a material selected from a group consisting of leather, plastic, canvas, rubber, and fabric.

12. The time indicating device of claim 9, further comprising:
at least two buttons configured with each strap such that the buttons protrude from the front side of each strap; and
at least two mating components mounted with the back of each toy;
wherein the mating components are configured to snap onto the respective buttons to removably secure the toys with the straps, when the mating components are aligned with the respective buttons and pressure is applied to join the mating components with the buttons.

13. The time indicating device of claim 9, further comprising:
at least a pair of metal eyelets configured with each strap such that the eyelets protrude from the front side of each strap; and
at least a pair of mating components mounted with the back surface of each toy;
wherein the eyelets are configured to snap into the respective mating components when the eyelets and the mating components are aligned and pressure is applied to join the eyelets with the mating components.

14. The time indicating device of claim 9, further comprising at least a pair of elastic bands on the back of each toy; the elastic bands sized to allow the toys to slide onto the straps when stretched and having sufficient elasticity to hold the straps when released, such that the toys are slid onto and positioned on the straps via the elastic bands.

15. The time indicating device of claim 9, wherein each toy attaches to the respective strap in two separated attaching areas, each strap has a length greater than a sum of a Velcro strip length and a distance between the two separated attaching areas.

16. The time indicating device of claim 9, wherein ratios of the lengths of the first and second toys to respective lengths of the first and second straps range from 0.4 to 0.8.

17. The time indicating device of claim 9, further comprising a pair of metal spring bars attached with the first ends of the straps, for coupling the straps to opposing sides of the watch.

18. A time indicating device with toys, comprising:
a watch having a time indicating face and an opposing back; and
first and second straps, each having a first end for attaching with the watch, and a free end distal to the watch,
wherein each strap comprises:
a first strap portion with the first end and a distal end,
a toy attached with the first strap portion at the distal end of the first strap portion,
a second strap portion having the free end and an proximal end that is proximal to the distal end of the first strap portion' wherein the toy is attached to the second strap at the proximal end;
wherein the bottom of each toy is flatter than the top of the toy.

19. The time indicating device of claim 18, further comprising optically transparent stitches for attaching the toys to the first and second portions of the first and second straps.

20. The time indicating device of claim 18, further comprising:
a first Velcro strip on a front side of the second portion of the first strap, proximate the free end; and
a complimentary Velcro strips on a back side of the second portion of the second strap, proximate the free end.

21. The time indicating device of claim 18, wherein the first and second straps comprise at least one of leather, plastic, canvas, rubber and fabric.

22. The time indicating device of claim 18, wherein the toy comprises stuffed toy.

23. The time indicating device of claim 18, wherein ratios of the lengths of the first and second toys to respective lengths of the first and second straps range from 0.4 to 0.8.

24. The time indicating device of claim 18, further comprising a pair of metal spring bars coupled to the first ends of the straps, for removably joining the straps with the watch.
